(19) United States
(12) Patent Application Publication
(10) Pub. No.: US 2015/0220736 A1
(43) Pub. Date: Aug. 6, 2015

(54) Continuous Memory Tamper Detection Through System Management Mode Integrity Verification

(71) Applicant: Dell Products, LP, Round Rock, TX (US)

(72) Inventors: Ricardo L. Martinez, Leander, TX (US); Dirie N. Herzi, Leander, TX (US)

(73) Assignee: Dell Products, LP, Round Rock, TX (US)

(21) Appl. No.: 14/172,268

(22) Filed: Feb. 4, 2014

(51) Int. Cl. G06F 21/57; G06F 13/24; G06F 12/14

(52) U.S. Cl. CPC G06F 21/572; G06F 12/1433; G06F 13/24

(57) ABSTRACT

An information handling system includes a plurality of memory locations, an embedded controller, and a basic input/output system (BIOS). The embedded controller provides an interrupt signal at random intervals. The BIOS is in communication with the embedded controller, and receives data associated with the plurality of memory locations including a first memory location. In response to the interrupt signals, the BIOS performs data integrity verification of the first memory location based on the data associated with the plurality of memory locations.

### FIELD OF THE DISCLOSURE

The present disclosure generally relates to continuous memory tamper detection in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

Operating systems depend on the integrity of software code that resides in and is executed from a memory of an information handling system. While the information handling system is up and running the information handling system can be attacked by malicious code circumventing or replacing the normal code.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system;

FIG. 2 is a block diagram of the information handling system of FIG. 1 in greater detail;

FIG. 3 is a flow diagram of a method for provisioning a data integrity verification operation for specific memory locations of the information handling system; and

FIG. 4 is a flow diagram illustrating a method for performing data verification of the memory regions in the information handling system.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

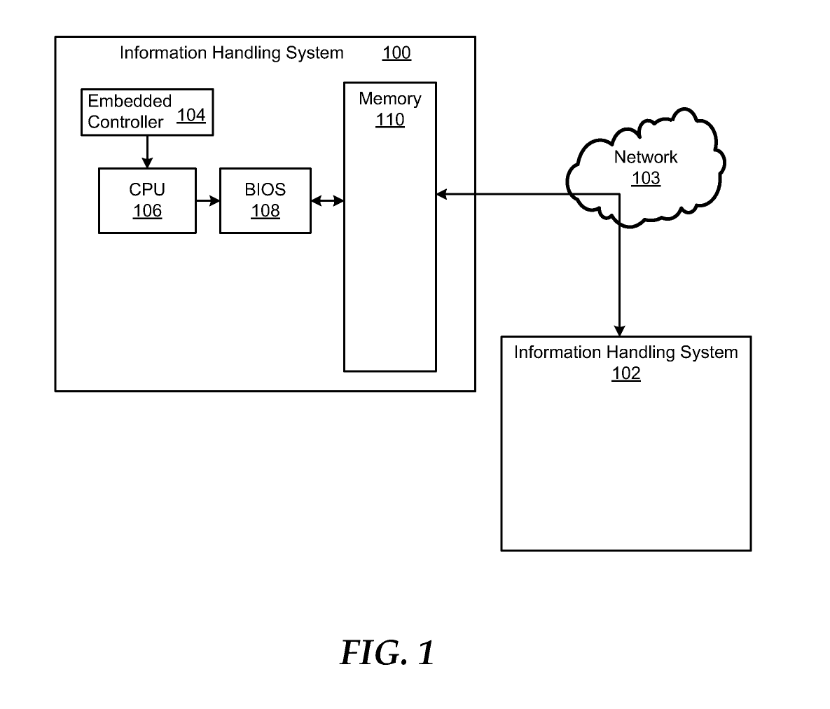

FIG. 1 shows information handling systems 100 and 102 that can communicate via a network 103. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes an embedded controller 104, a central processing unit (CPU) 106, a basic input/output system (BIOS) 108, and a memory 110. The embedded controller 104 is in communication with the CPU 106, which in turn is in communication with the BIOS 108. The BIOS 108 is also in communication with the memory 110. The memory 110 can store data/code to be used by an operating system (OS) kernel of the information handling system 100, or by user applications running on the information handling system. In an embodiment, the memory 110 can also be used to mirror data stored in the flash memory of the BIOS 108. During operation of the information handling system 100, the data/code stored the memory 110 can be accessed by the OS kernel and/or the user applications, and the data/code read from the memory can manipulate how the OS kernel and/or the user applications execute. Thus, the data/code stored in particular memory locations of memory 110 can be important to the operation of the information handling system 110, such that these memory locations can be referred to as critical memory locations of the memory 110. The data/code stored at the critical memory locations can include a kernel root of trust, encryption keys or signing algorithms, OS or user application data, or the like.

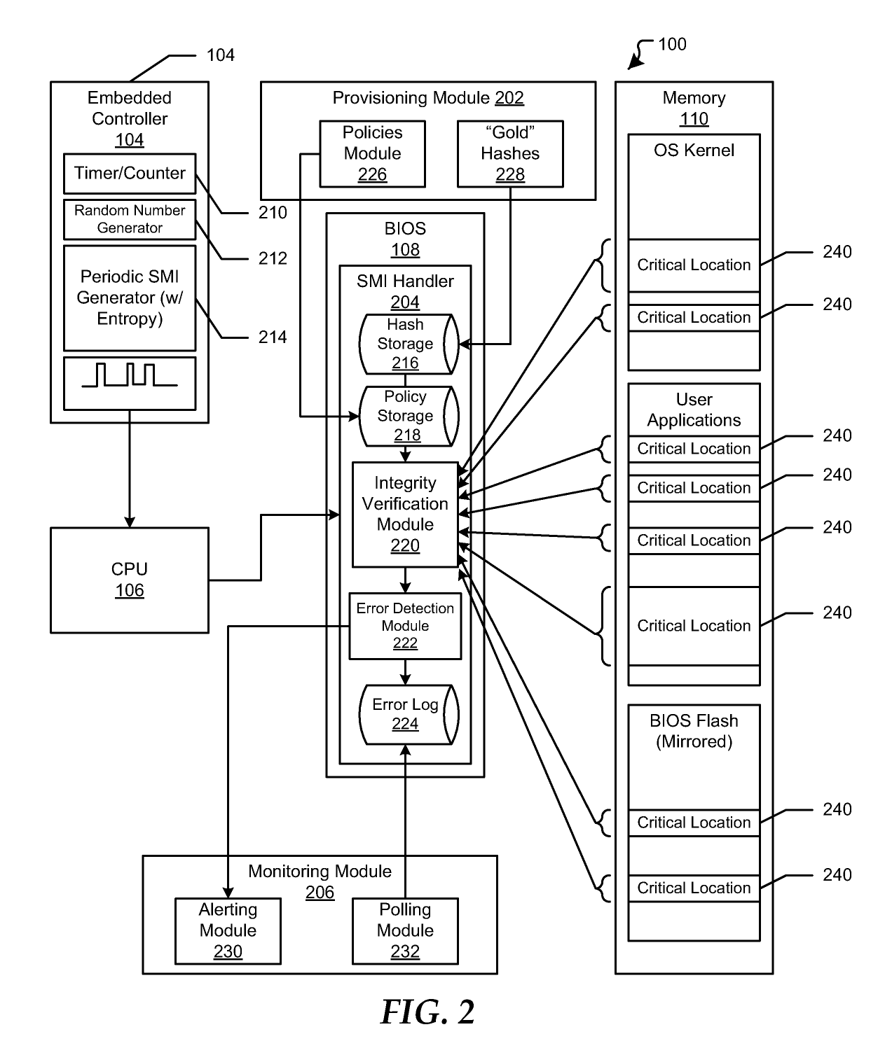

A person with malicious intent can utilize information handling system 102 and the network 103 to communicate with and to infiltrate the information handling system 100. Once that person, sometimes known as a hacker, has gained access to the information handling system 100, he or she can manipulate the code or data stored in these critical memory locations of the memory 110. The manipulated data in memory 110 can enable the hacker to change how the OS kernel and/or user applications operate or to disable OS security protections to allow the hacker to gain more control of the information handling system 100. Thus, the OS of the information handling system 100 can be configured to check the data/code stored in the critical memory locations of the memory 110. However, if the OS performs these checks at standard periodic intervals by the OS of the information handling system 100, the hacker can utilize malicious code stored in the critical memory location to disable the data verification in the OS, or to change/restore the appropriate data/code stored in the memory 110 prior to the known time intervals, such that the hacker's activities may not be detected by the OS of the information handling system 100. Therefore, in a particular embodiment the BIOS 108, in conjunction with the embedded controller 104, can be utilized by the information hearing system 100 to provide a robust data verification process to check the data/code stored in the memory 110, which will be described with respect to in FIG. 2 below.

FIG. 2 shows the information handling system 100 of FIG. 1 in more detail. The information handling system 100 includes a provisioning module 202, a system management interrupt (SMI) handler 204, and a monitoring module 206. The information handling system 100 also includes the embedded controller 104, the CPU 106, the BIOS 108, and the memory 110. The embedded controller 104 includes a timer/counter 210, a random number generator 212, and a periodic SMI generator 214. The bias 108 includes the SMI handler 204, which in turn includes hash storage 216, policy storage 218, an integrity verification module 220, an error detection module 222, and an error log 224. The provisioning module 202 includes a policies module 226 and gold hashes 228. The monitoring module 206 includes an alerting module 230 and a polling module 232. The modules of the information handling system 100 can be hardware, software, or a combination of hardware and software. The memory 110 includes different memory locations, such as OS kernel memory locations, user application memory locations, and a mirrored memory locations of the flash memory of the BIOS 108. Specific memory locations 240 within the memory 110 can be utilized to store data/code that is important to the operation of OS kernel, user applications, and BIOS 108 of the information handling system 110. These memory locations 240 can be referred to as critical memory locations of the memory 110.

The information handling system 100 can cause the BIOS 108 to periodically perform a data integrity verification operation to check the data/code stored in the critical locations 240. In an embodiment, the data integrity verification operation can be performed by the BIOS 108 during runtime of the OS of the information handling system 100. The embedded controller 104 and the BIOS 108 can have privileges in the information handling system to execute in a system management mode (SMM) during runtime of the OS. The SMM of the information handling system 100 can be completely independent of the OS memory 100, such that an attack on the OS memory 110 cannot effect the operation of the embedded controller 104, the BIOS 108, and a SMM memory controlled by the BIOS. In an embodiment, the BIOS 108 controls all of the code for the SMM, and the SMM memory is locked down by the BIOS during runtime of the OS using chipset mechanisms accessible by the BIOS.

During the start-up of the information system 100, the provisioning module 202 can access the critical memory locations of the BIOS flash memory and can then produce separate hashes of the data/code stored in each of the critical memory locations of the BIOS flash memory. The hashes of the BIOS flash memory locations can be referred to as ‘gold’ hashes 228, because the hashes are associated with data/code of the BIOS 108, which is utilized to perform the data integrity verification operation. In an embodiment, the provisioning module 202 can store different policies for the data integrity verification process in the policies module 226. These policies can include priority levels for the critical memory locations. In an embodiment, the priority levels can set how often a particular critical memory location is checked, such as in response to each interrupt signal, in response to every other interrupt signal, or the like. The provisioning module 202 can provide the policies stored in the policies module 226 and the gold hashes 228 to the SMI handler 204 of the BIOS 108. The SMI handler 204 can store the policies in the policy storage 218, and the gold hashes 228 in the hash storage 216. The policies and hashes can be retrieved by the integrity verification module 220 during data integrity verification operations.

Also during the start up of the information system 100, the OS can identify the critical memory locations 240 in memory 110 for the OS kernel and the user application. The OS can then produce hashes of the data/code stored in the critical memory locations 240. The OS can also have policy information for performing the data integrity verification operation on the critical memory locations 240. In an embodiment, the policy information can include rules on logging verification failures detected during the data integrity verification operation, policies on how to alert a user of the detected failures, and the like. The OS can then provide the hashes, the policy information, and the addresses of the critical memory locations 240 to the integrity verification module 220 of the management handler 204. In an embodiment, the OS can provide this data associated with the memory location 240 to the integrity verification module 220 by calling a BIOS application programming interface (API). The integrity verification module 220 of the BIOS 108 can then store the information passed to the BIOS via the BIOS API in SMM memory of the BIOS. In particular, the hash storage 216 and the policy storage 218 can be portions of the SMM memory, such that the hashes of the data/code in the memory location 240 can be stored in the hash storage 216 and the policy information can be stored in the policy storage 218. In another embodiment, the information passed to the BIOS via the BIOS API can be stored in a non-volatile random access memory (NVRAM) of the BIOS. In this embodiment, the hash storage 216 and the policy storage 218 are portions of the NVRAM.

During runtime of the information system 100, the embedded controller 104 can utilize timer/counter 210 and the random number generator 212 to produce inputs to the periodic SMI generator 214 at random intervals. For each interrupt interval, the random number generator 212 can provide a random number to the timer/counter 210, which in turn can used the random number as the threshold for the triggering the timer/counter. For example, if the random number generator 212 provides two hundred as the random number to the timer/counter 210, the timer/counter can count to two hundred and can then provide an input to the periodic SMI generator 214. During the next interval, the random number generator 212 can provide one hundred as the random number to the timer/counter 210, which can then count to one hundred and can provide an input to the periodic SMI generator 214. The periodic SMI generator 214 can then provide an interrupt signal in response to each input from the timer/counter 210. Thus, the periodic SMI generator 214 can provide interrupts signals at random intervals based on inputs from the combination of the timer/counter 210 and the random number generator 212.

The periodic SMI generator 214 can provide the interrupts signal to SMI handler 204. In an embodiment, the interrupt signal can be provided to the SMI handler 204 of the BIOS 108 via the CPU 106. In another embodiment, the interrupt signal can be provided directly from the periodic SMI generator 214 to the SMI handler 204 of the BIOS 108. In response to receiving the interrupt signal from periodic SMI generator 214 of the embedded controller 104, the BIOS 108 can launch the integrity verification operation in the integrity verification module 220, which in turn can retrieve hashes, addresses, and policy information for the critical memory locations 240 from hash storage 216 and the policy storage 218. The hashes, addresses, and policy information can be for the critical memory locations 240 associated the OS kernel, the user applications, and mirrored BIOS flash stored in the memory 110. The integrity verification module 220 can utilize the policy information to determine which of the critical memory locations 240 are scheduled to have the data integrity verification performed.

The integrity verification module 220 can then read the data/code from each of the critical memory locations 240 scheduled for data integrity verification. The integrity verification module 220 can then produce a separate hash for the data/store stored at each of the memory locations 240. The integrity verification module 220 provide the produced hash and the stored hash for each memory location 240 to the error detection module 222, which in turn can compare the stored hash received from hash storage location 216 to the generated hash of the current data/code in the corresponding critical location 240 of memory 110. The error detection module 222 can then determine whether the stored hash of a specific critical memory location 240 matches the newly generated hash for the same critical memory location. If the two hashes match the error detection module 222 can continue the data integrity verification operation by comparing the stored and generated hashes for the next critical memory location 240. However, if the stored and generated hashes for a particular critical memory location do not match, the error detection module 222 can provide an error associated with that particular critical memory location to the user of the information handling system 100 based on the policy information stored in the policy storage 218. In one embodiment, the error detection module 222 can push a warning signal to the alerting module 230 of the monitoring module 206, which in turn can notify the user that a memory location 240 has failed the data integrity verification process. The warning signal may be provide from the error detection module 222 to the alerting module 230 via an API call to the monitoring module 206. In another embodiment, the error detection module 222 can store the failure of the specific memory location 240 in the error log 224 and continue in the data integrity verification operation to compare the hashes for the next memory location 240. In this embodiment, the polling module 232 can poll/pull the error log 224 to retrieve the error log for the data integrity verification operation. The error log 224 may be retrieved by the polling module 232 via an API poll/push command. The monitoring module 206 can then determine whether any memory locations 240 failed the data integrity verification process based on the information in the error log 224, and notify the user of any failures in the data/code of the critical memory locations 240. In another embodiment, the error detection module 222 can both send the warning signal to the alerting module 230, and store information in the error log 224.

The SMI handler 204 can repeat the integrity verification operation in response to each interrupt signal received from the embedded controller 104. Thus, the random intervals of the interrupt signals provided to the SMI handler 204 of the BIOS 108 can prevent the hacker using malware that can change the data/code of the critical member locations 240 back to its original data/code prior to known intervals of the data integrity verification operations based on each interval between the interrupt signals being random in response to the number generated by the random number generator 212.

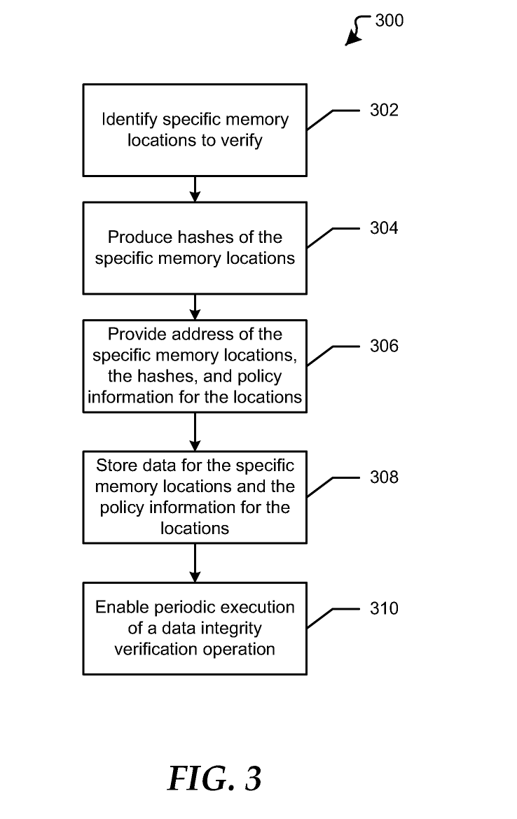

FIG. 3 shows a flow diagram of a method 300 for provisioning a data integrity verification operation for specific memory locations of an information handling system. At block 302, specific memory locations are identified as critical memory locations that are to have the data/code stored at these specific memory locations verified. Hashes of the specific memory locations are produced at block 304. In an embodiment, these hashes can be produced either by a provisioning module or by the OS of the information handling system depending on the location of the specific memory location. At block 306, the address of each of the specific memory locations, the hashes for the memory locations, and policy information for performing the data integrity verification operation are provided to a BIOS. In an embodiment the hashes, addresses, and policy information are provided from the OS of the information handling system to the SMI handler of the BIOS.

The policy information can include rules on logging failure events detection during the data integrity verification operation, policies on how to alert a user of the detected failures, and the like. The priority information can also include information on how often data/code of each specific memory location is to be verified. At block 308, data associated the specific memory locations, such as the hashes and addresses of the memory location, along with the policy information is stored in the BIOS. Periodic execution of a data integrity verification operation is enabled at block 310.

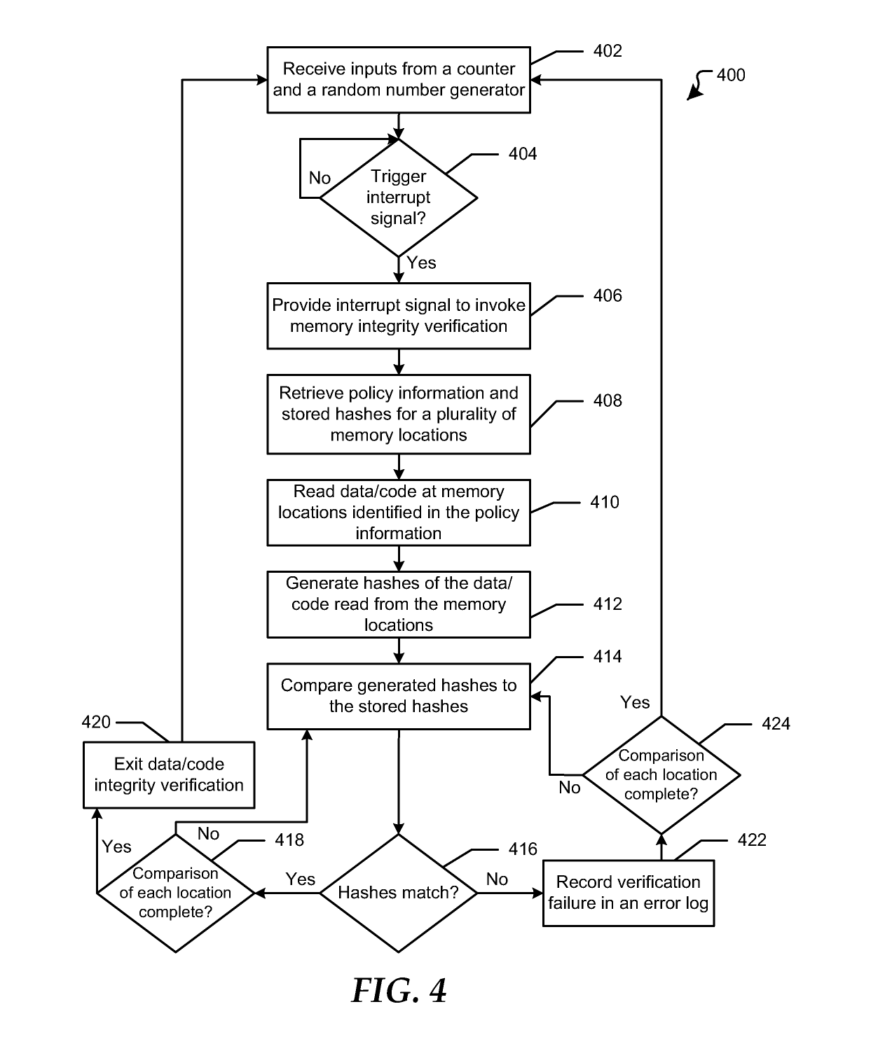

FIG. 4 shows a flow diagram illustrating a method 400 for performing data verification of specific memory regions in an information handling system. At block 402, inputs from a counter and random number generator are received. These inputs can be received at random intervals based on a random number generated by the random number generator. At block 404, a determination is made whether to trigger an interrupt signal. In a particular embodiment, the trigger for an interrupt signal can be in response to each input received from the counter/random number generator. When it is determined to trigger an interrupt signal, an interrupt signal is provided, to a BIOS, to invoke a data integrity verification operation at block 406. Depending on the embodiment, the interrupt can be provided to the BIOS via an embedded controller sending the signal through a CPU or the embedded controller providing the interrupt signal directly to the BIOS.

At block 408, policy information and stored hashes for a plurality of memory locations are retrieved. The current data/code stored at the memory locations are is read at block 410. At block 412, a hash of the current data/code stored at each memory locations identified in the policy information is generated. The generated hashes are compared to the stored hashes on a memory location by memory location basis at block 414. At block 416, a determination is made whether the generated hash matches the stored hash for a particular memory location. If the generated hash matches the stored hash, a determination is made whether the comparison of the hashes for each memory location has been completed at block 418. If the comparison of hashes has not been completed for each memory location, the flow continues as stated above at block 414. If the comparison of hashes has been completed for each memory location, the data integrity verification process is exited at block 420, and the flow continues as stated above at block 402.

If the generated hash for a particular location does not match the stored hash, data/code verification failure for that memory location is recorded in an error log at block 422. At block 424, a determination is made whether the comparison of the hashes for each memory location has been completed. If the comparison of hashes has not been completed for each memory location, the flow continues as stated above at block 414. If the comparison of hashes has been completed for each memory location, the flow continues as stated above at block 402.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a plurality of memory locations;
an embedded controller configured to provide an interrupt signal at random intervals; and
a basic input/output system (BIOS) in communication with the embedded controller, the BIOS to receive data associated with the plurality of memory locations including a first memory location, and in response to the interrupt signals, to perform data integrity verification on the first memory location based on the data associated with the memory locations.

2. The information handling system of claim 1, wherein, while the data integrity verification is performed, the BIOS is configured to read data stored at the first memory location, to produce a hash of the data at the first memory location, and to compare the produced hash with a stored hash for the first memory location.

3. The information handling system of claim 2, wherein the data integrity verification fails in response to the produced hash not being the same as the stored hash for the first memory location.

4. The information handling system of claim 3, wherein the BIOS is further configured to produce an entry in an error log in response to the data integrity verification of the first memory location failing.

5. The information handling system of claim 1, wherein the data includes a hash of each of the specific memory locations, policy data for the data integrity verification, and addresses of each of the plurality memory locations.

6. The information handling system of claim 5, wherein the policy data includes information for the priority of the specific memory locations including how often each of the plurality memory locations is verified.

7. The information handling system of claim 1, wherein a length of time between interrupt signals differs from interrupt signal to interrupt signal based on an output of a random number generator.

8. The information handling system of claim 1, wherein the plurality of memory locations store data for an operating system kernel of the information handling system, and data for applications running on the information handling system.

9. A method comprising:
receiving, at a basic input/output system (BIOS), data associated with a plurality of memory locations including a first memory location;
receiving an interrupt signal at random intervals; and
in response to the interrupt signals, performing, at the BIOS, data integrity verification on the first memory location based on the data associated with the first memory location.

10. The method of claim 9, wherein performing the data integrity verification comprises:
reading data stored at the first memory location;
producing a hash of the data at the first memory location; and
comparing the produced hash with a stored hash for the first memory location.

11. The method of claim 10, further comprising:
failing the data integrity verification in response to the produced hash not being the same as the stored hash for the first memory location.

12. The method of claim 11, further comprising:
producing an entry in an error log in response the data integrity verification of the first memory location failing.

13. The method of claim 9, wherein the data includes a hash of each of the specific memory locations, policy data for the data integrity verification, and addresses of each of the plurality memory locations.

14. The method of claim 13, wherein the policy data includes information for the priority of the specific memory locations including how often each of the plurality memory locations is verified.

15. The method of claim 9, wherein a length of time between interrupt signals differs from interrupt signal to interrupt signal based on an output of a random number generator.

16. The method of claim 9, further comprising:
storing data for an operating system kernel of the information handling system in the plurality of memory locations; and
storing data for applications running on the information handling system in the plurality of memory locations.

17. A method comprising:
receiving, at a basic input/output system (BIOS), a hash of data stored at a memory location of an information handling system;
storing the hash;
receiving, at the BIOS, an interrupt signal at random intervals; and
in response to the interrupt signals, reading, at the BIOS, the current data stored at the memory location;
performing, at the BIOS, data integrity verification on the current data stored at the memory location based on the stored hash.

18. The method of claim 17, wherein performing the data integrity verification comprises:
producing a hash of the current data at the memory location;
comparing the produced hash with the stored hash for the memory location; and
providing an verification failure warning signal.

19. The method of claim 17, wherein the first memory location in critical data for operation of an operating system kernel of the information handling system.

20. The method of claim 17, wherein the first memory location in critical data for operation of user application of the information handling system.
